(19) United States
(12) Patent Application Publication
(10) Pub. No.: US 2003/0147450 A1
(43) Pub. Date: Aug. 7, 2003

(54) Temperature measuring device and method of using and making same

(75) Inventors: Robert Witonsky, Princeton, NJ (US); John Estill, Carlsbad, CA (US); Ron Benincasa, Olivenhain, CA (US); John Scarantino, Mercerville, NJ (US); Timothy Ursell, Towaco, NJ (US); Albert Waecker, Lawrence, NJ (US)

Correspondence Address: FOLEY & LARDNER, 402 WEST BROADWAY, 23RD FLOOR, SAN DIEGO, CA, 92101

(73) Assignee: Medical Indicators, Inc.

(21) Appl. No.: 10/128,216

(22) Filed: Apr. 22, 2002

Related U.S. Application Data
(60) Provisional application No. 60/355,375, filed on Feb. 6, 2002.

(51) Int. Cl. G01K 1/14; G01K 13/00; G01K 11/12

(52) U.S. Cl. 374/141; 374/162

(57) ABSTRACT

A temperature measuring device and method of using it are disclosed herein. A temperature sensing strip is disposed within a housing used for agitating a material, the temperature of which is to be measured. The strip has a series of sensor dots containing liquid crystal material.

### RELATED APPLICATION

This application is related to, and claims priority under 35 U.S.C. §119(e) of, U.S. provisional applications Serial No. 06/355,375, titled “Temperature Indicating Stir Stick”, filed Feb. 6, 2002, which is hereby incorporated by reference in their entirety.

### BACKGROUND OF THE INVENTION

1. Field of the Invention

The invention relates in general to a new and improved device for measuring the temperature of a material, as well as a method of using the device and a method of making it. More particularly, the invention relates to such a device, which can be used for measuring the temperature of comestible liquids such as coffee, tea, hot milk, or the like, as well as for measuring the temperature of other substances such as bath water, hot tub water or the like.

1. Related Art

The information contained in this section relates to the background of the art of the present invention without any admission as to whether or not it legally constitutes prior art.

Certain comestible products are served at elevated temperatures. In this regard, hot coffee or tea, hot milk or hot chocolate drinks are consumed at elevated temperatures to enhance their enjoyment. These products are sometimes consumed with undesirable effects such as the scalding or burning of the mouth or tongue. For example, certain coffee drinkers prefer coffee at extremely hot temperatures, while others prefer it at moderately warm temperatures. The extremely not coffee can result in the unwanted result of scalding the mouth or tongue.

On the other hand, some drinkers may typically take a small sip to determine the temperature of the drink prior to fully consuming it. The small sip may result in consuming a distasteful product if, for example, the coffee is cold or at room temperature.

Other persons, such as babies, may be inadvertently scalded from drinking milk or formula from a bottle, if the temperature of the material is too hot for comfortable consumption by such a young person. Thus it is desirable to provide a technique for a person to use for determining the temperature of a comestible they are about to consume without the necessity of first tasting or otherwise touching the actual hot consumable.

### BRIEF DESCRIPTION OF THE DRAWINGS

In the following, the invention will be explained in further detail with reference to the drawings, in which:

FIG. 1 is a pictorial view of a temperature measuring device, which is constructed in accordance with an embodiment of the present invention;

FIG. 2 is an enlarged fragmentary front elevational view of the temperature measuring device of FIG. 1;

FIG. 3 is a fragmentary side elevational view of the device of FIG. 2;

FIG. 4 is a greatly enlarged sectional view of a sensor dot of the device of FIG. 2;

FIG. 5 is a sectional view of the device of FIG. 2 taken substantially on line 5-5 thereof;

FIG. 6 is a fragmentary pictorial view of another temperature measuring device, which is constructed in accordance with another embodiment of he present invention;

FIG. 7 is a fragmentary front elevational view of the device of FIG. 6; and

FIG. 8 is a side elevational, fragmentary view of the device of FIG. 7.

### DESCRIPTION OF CERTAIN EMBODIMENTS OF THE INVENTION

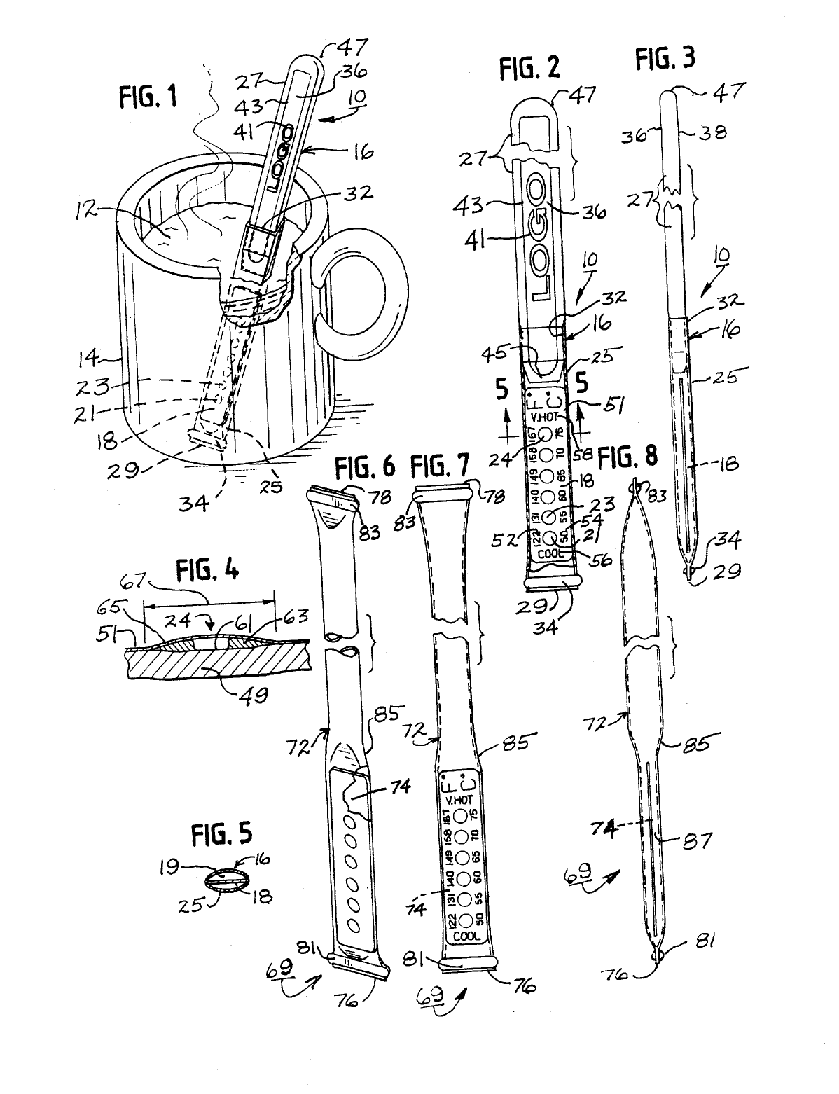

Referring now to the drawings, and more particularly to FIGS. 1, 2, 3, 4 and 5, there is shown a temperature measuring device 10 in the form of a stir stick, which is constructed in accordance with the preferred embodiment of the present invention, and which is disposed in a material 12 such as hot coffee in a coffee cup 14. The stir stick 10 performs two separate functions.

The stick 10 can be used to stir the coffee 12 for mixing any ingredients added thereto.

Thus, the stick 10 can help to distribute uniformly cooler liquids such as cream in a hot liquid such as coffee, to adjust the overall temperature of the liquid or other material to a more desirable or suitable temperature. Additionally, the stick 10, as hereinafter described in greater detail, measures the temperature of the coffee 12 to alert the drinker as to whether or not the temperature of the coffee 12 is suitable for drinking purposes.

The stir stick device 10 generally comprises an elongated housing 16 having a temperature sensing strip 18 disposed within the hollow transparent housing 16. The housing 16 is rigid and serves to agitate the coffee 12 for mixing purposes. The temperature sensing strip 18 is spaced from the interior surface of the housing 16 by a space 19 (FIG. 5) so that the temperature sensing strip 18 is partially insulated from the hot liquid or other substance. When the stick 10 is withdrawn from the coffee 12 to allow the user to take a reading of the temperature of the coffee, the reading will persist sufficiently long to take the reading before the sensing strip 18 starts to cool and thus provide an inaccurate reading. The housing 16 engaging the material enables the temperature sensing strip 18 to detect the temperature of the coffee 12.

The stir stick performs the dual function of mixing the coffee or other material, as well as allowing the user to determine the temperature of the material to avoid unwanted injury or other undesirable effects, such as drinking cold coffee. The temperature sensing strip 18 includes a series of sensor dots such as sensor dots 21 and 23. The sensor dots change colors with temperature to provide an indication of the temperature of the surrounding environment as hereinafter described in greater detail.

The sensor dots preferably include liquid crystal material, such as the material and arrangement as disclosed in U.S. Pat. No. 6,284,078B1 and 6,257,759B1, which are incorporated herein by reference. Other temperature indicating techniques, devices and substances may also be employed as may hereinafter become apparent to those skilled in the art.

In use, a person inserts the stir stick 10 into the material 12 as shown in FIG. 1. The temperature sensing strip 18 is disposed at the bottom end portion thereof, immersed in the material 12, and the upper end of the stir stick 10 extends above the level of the liquid. The upper end portion of the stir stick 10 can be grasped by the hand of the user to stir or otherwise agitate the material 12. While so doing, the temperature sensing strip 18, having the sensor dots 21 and 23 immersed in the material 12 register the temperature thereof. Thereafter, the device 10 can be withdrawn from the material 12 and the sensor dots can be viewed as a temperature readout so that the user can judge the temperature of the liquid before consuming it.

The stick 10 can be used as a give-away promotional item by companies who sell coffee or tea by the drink. Thus, after the stick 10 has been used for its initial use of stirring the coffee 12 and measuring its temperature, the stick 10 can be taken with the user and employed for other uses, such as the stirring and taking temperature measurements of other products being heated or reheated such as hot tea, hot milk, soup or other comestibles, as well as for measuring the temperature of other substances such as bath water, hot tub water and other applications which will become apparent to the user.

Considering now the housing 16 in greater detail, the housing 16 includes a hollow bottom housing portion 25 for confining the temperature sensing strip 18 and is generally oval in shape throughout its length. The housing portion 25 may be composed of thermoplastic material which is preferably at least in part transparent or translucent so that the strip 18 can be viewed or seen therethrough. It should be understood that only a portion of the housing may be transparent or translucent. The housing portion 25 includes a top solid housing portion 27 which is fixedly attached to the hollow housing portion 25. The top housing portion 27 is preferably composed of thermoplastic material and is heat sealed to the hollow housing portion 25.

The hollow housing portion 25 includes a sealed bottom end 29 and an open top end 32 for receiving the top solid housing portion 27. A bead portion 34 at the bottom end 29 serves as a mass or weight to help overcome buoyancy of the device 10.

The upper housing portion 27 includes a front flat surface 36 and a rear flat surface 38.

An advertising logo indicia 41 on a label 43 is affixed to the flat surface 36. In this manner, the label can be changed for each company that provides the device 10 to its customers to serve for advertising purposes.

A tapered end 45 of the top solid portion 27 is adapted to fit into the complementary shaped open top end 32 of the hollow portion 25. In this manner, the two parts of the housing can be interconnected readily during the manufacturing process by slipping the tapered end 45 into the open top end 32, and then heat sealed or heat welded together to form a rigid configuration. The top solid housing portion 27 has a rounded top end 47 for aesthetic purposes, as well as preventing unwanted injury by having sharp corners.

Considering now the temperature sensing strip 18 in greater detail with reference to FIGS. 2 and 4 of the drawings, the strip 18 includes a thin backing member 49 having a front face 51, which includes Fahrenheit indicia such as indicia 52 and Celsius indicia such as indicia 54 adjacent to the corresponding sensor dots. Warning indicia such as indicia 56 configured in the shape of the word “COOL” at the bottom end of the column of sensor dots and indicia 58 configured in the shape of the words “V HOT” standing for the words “VERY HOT”.

Considering now the sensor dots, with reference to FIG. 4, the sensor dot 24 is similar to the other sensor dots. Each sensor dot is designed to register a different temperature. An embossed depression 61 in the front face of the thin backing member 49 receives a quantity of liquid crystal material 63 and is retained in place by a transparent outer sheet 65, which is heat sealed to-the backing member 49 as described in greater detail in the foregoing mentioned U.S. patents. The liquid crystal material assumes a color such as a color green at low temperatures. At a high temperature, the liquid crystal material changes to a gray or clear color to reveal a black background on a black pigment layer on the exterior top surface of the depression 61 to provide a temperature indication.

The dot 21 is circular in configuration and has a diameter 67. However, other configurations may also be employed.

Considering now a temperature measuring device 69, there is shown another stir stick which is constructed in accordance with another embodiment of the invention, and which is shown in FIGS. 6, 7 and 8. The device 69 is similar to the device 10 except that the device 69 has a one-part housing.

The device 69 includes an elongated housing 72 which is similar to the housing 16, except that it comprises one part. A temperature sensing strip 74 is disposed in the bottom portion of the housing 72 and is similar to the temperature strip 18 of FIG. 1.

The housing 72 includes a sealed bottom end 76 which is similar to the sealed bottom end 29 of the device 10. The housing 72 includes a sealed top end 78, which is similar to the bottom end 76. A bottom beaded portion 81 serves a similar purpose as the bottom beaded end 34 provides for the device 10. For symmetry purposes, a top beaded portion 83 is disposed at the sealed top end 78. The beaded portions serve to provide mass to help reduce buoyancy of the device 69.

The temperature sensing strip 74 is secured within the bottom portion of the housing 72 by means of an intermediate tapered transition portion 85 to trap the strip 75 in place. In this regard, the bottom portion of the housing 72 is flattened and is closely spaced from the strip 75 via a space 87 which serves a similar purpose as the space 19 shown in FIG. 5.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A device for measuring the temperature of a material, comprising:
a rigid elongated housing for agitating the material;
a temperature sensing strip disposed within said housing so that a portion of said housing engages the material to measure its temperature;
said strip having a series of adjacent sensor dots, each having liquid crystal material contained therein for changing colors with changes in the temperature of the material to provide a visible temperature measurement readout; and
wherein said sensor dots are each spaced from the interior of said housing to insulate the dots from the ambient environment so that the temperature readout is relatively stable.

2. The device according to claim 1, wherein said sensor dots are disposed in a column in said housing at the bottom portion thereof;

3. The device according to claim 1, wherein said housing includes a hollow bottom portion and a top solid portion;

4. The device according to claim 2, wherein said top portion includes a surface bearing logo indicia;

5. The device according to claim 3, wherein said solid portion has a bottom tapered end for fitting into said hollow bottom portion;

6. The device according to claim 1, wherein at least one end of said housing has a beaded portion;

7. The device according to claim 1, wherein both ends of said housing are sealed;

8. The device according to claim 1, wherein both ends of said housing include a beaded portion to help reduce buoyancy.

9. The device according to claim 1, wherein said housing is one piece and has an intermediate tapered portion to trap said strip in the bottom portion thereof;

10. A method of using a device for measuring the temperature of a material, comprising:
using the device which is elongated and includes temperature sensors at substantially one end thereof;
inserting the device into the material;
moving the device to agitate the material;
withdrawing the device from the material to permit viewing the temperature sensors for providing an indication of the temperature of the material; and
re-inserting the device into the material to enable a further temperature reading to be taken for monitoring temperature changes of the material.

11. A method of making a device for measuring the temperature of a material, comprising:
using an elongated, substantially rigid housing;
inserting a temperature sensing strip having temperature sensors disposed thereon into the hollow interior of the housing and disposing the temperature sensors of the strip at the bottom portion of the housing; and
sealing the housing to retain the strip therewithin in a liquid tight manner.
